(19) United States
(12) Patent Application Publication
(10) Pub. No.: US 2015/0125593 A1
(43) Pub. Date: May 7, 2015

(54) METHOD OF PATTERNING ELASTOMERIC POLYMER MATERIAL

(71) Applicant: SAMSUNG ELECTRONICS CO., LTD., Suwon-si (KR)

(72) Inventors: Jung-kyun IM, Asan-si (KR); Jong-jin PARK, Hwaseong-si (KR)

(73) Assignee: SAMSUNG ELECTRONICS CO., LTD., Suwon-si (KR)

(21) Appl. No.: 14/534,306

(22) Filed: Nov. 6, 2014

(30) Foreign Application Priority Data
Nov. 6, 2013 (KR) 10-2013-0134364

(51) Int. Cl. C09D 183/04; B41M 3/00

(52) U.S. Cl. CPC C09D 183/04; B41M 3/006
USPC 427/79; 427/256; 427/58; 438/780

(57) ABSTRACT

A method of patterning an elastomeric polymer material includes: (a) dissolving a precursor of the elastomeric polymer material in a solvent to give an elastomeric polymer precursor solution; and (b) forming a pattern from the elastomeric polymer precursor solution on a base by using a printer, wherein a temperature of the base is maintained to be about 10° C.-30° C. higher than a boiling point of the solvent.

### CROSS-REFERENCE TO RELATED APPLICATIONS

This application claims the benefit of Korean Patent Application No. 10-2013-0134364, filed on Nov. 6, 2013, in the Korean Intellectual Property Office, the disclosure of which is incorporated herein in its entirety by reference.

### BACKGROUND

1. Field

The present disclosure relates to methods of patterning an elastomeric polymer material.

2. Description of the Related Art

In general, lithography methods have been used to pattern an elastomeric polymer material to a micrometer or smaller width. However, these lithography methods require expensive large equipment and involve complicated processes. Furthermore, the lithography methods may be incompatible with some materials forming an underlying base.

Thus, it may be more easy to pattern a polymer material via a self-assembly method. However, the self-assembly method is incompatible with elastomeric polymer materials that require curing monomers thereof with a curing agent and polymerizing the mixture of monomers and the curing agent in a certain ratio at a predetermined temperature for a specific time duration. A roll-to-roll method and a micro-contact printing method are other methods for patterning a polymer material. However, these methods may not be used to pattern elastomeric polymer materials that require curing with a curing agent.

Therefore, there is a need to develop an easy, economical method of patterning an elastomeric polymer material as an alternative to lithography methods.

### SUMMARY

Provided are methods of patterning an elastomeric polymer material.

Provided are methods of manufacturing a pressure sensor by any of the methods of patterning an elastomeric polymer material.

Additional aspects will be set forth in part in the description which follows and, in part, will be apparent from the description, or may be learned by practice of the presented embodiments.

According to an aspect of the present disclosure, a method of patterning an elastomeric polymer material includes: (a) dissolving or dispersing a precursor of the elastomeric polymer material in a solvent to prepare an elastomeric polymer precursor solution; and (b) forming a pattern from the elastomeric polymer precursor solution on a base using a printer, wherein a temperature of the base is maintained to be about 10° C.-30° C. higher than a boiling point of the solvent.

The precursor of the elastomeric polymer material may include a monomer of the elastomeric polymer material and a curing agent.

The elastomeric polymer material may include a silicon-based polymer material. The elastomeric polymer material may include polydimethlysiloxane, poly(styrene-b-butadiene-b-styrene) (SBS), poly(styrene-b-ethylenebutadiene-b-styrene) (SEBS), polychloroprene, butyl rubber, ethylenepropylene rubber, polyurethane, thiokol polysulfide, polyacrylate, acrylonitrile-butadiene rubber (NBR), isoprene rubber, or natural rubber.

The curing agent may include a platinum catalyst.

The solvent may include dichloromethane, chloroform, toluene, ethylacetate, tetrahydrofuran, dimethlysiloxane, dimethylformamide, or acetonitrile.

The elastomeric polymer precursor solution may have a viscosity that allows forming the pattern by printing.

The forming of the pattern by using the printer may be performed by nozzle printing, roll printing, or inkjet printing.

The base may include a substrate, a film, a polymer in fibrous form, glass, silicon, or metal.

The temperature of the base may be maintained to be about 10° C.-20° C. higher than the boiling point of the solvent.

The pattern may have a width of about 1-500 μm.

The step (b) may be repeated to increase a height of the pattern of the elastomeric polymer material. The pattern of the elastomeric polymer material may have a height of about 0.1-250 μm.

The printer may include a dispenser for dispensing, for example spraying the elastomeric polymer precursor solution, and the dispenser is movable in a first direction and a second direction that are parallel to a surface of the base and in a third direction perpendicular to the surface of the base. The method may further include moving the dispenser in the third direction to maintain a constant distance from the previously formed pattern when the step (b) of the forming of the pattern is repeated.

In the method, the printer may include a dispenser for dispensing, for example spraying the elastomeric polymer precursor solution and a stage on which the base is to be loaded, and the stage may be movable in a first direction and a second direction that are parallel to a surface of the base and in a third direction perpendicular to the surface of the base.

According to another aspect of the present disclosure, a method of manufacturing a pressure sensor includes: forming a first electrode; forming a pattern of an elastomeric polymer material according to any of the methods according to the above-described embodiments; and forming a second electrode on the pattern of the elastomeric polymer material.

The first electrode may include, but not limited to, a metal, for example, gold, silver, copper, iron, or indium; a conductive metal oxide, for example, indium tin oxide (ITO); or carbon nanotube. The second electrode may include, but not limited to, a metal, for example, gold, silver, copper, iron, or indium; a conductive metal oxide, for example, ITO; or carbon nanotube.

### BRIEF DESCRIPTION OF THE DRAWINGS

These and/or other aspects will become apparent and more readily appreciated from the following description of the embodiments, taken in conjunction with the accompanying drawings in which:

FIG. 1 is a flowchart illustrating a method of forming a pattern of an elastomeric polymer material pattern, according to an embodiment of the present disclosure;

FIG. 2 is a schematic view illustrating a method of forming an elastomeric polymer material pattern by using a nozzle printer, according to an embodiment of the present disclosure;

FIG. 3 is an exploded perspective view of a pressure sensor using an elastomeric polymer material pattern, according to an embodiment of the present disclosure;

FIGS. 4A and 4B are optical microscopic images of ECOFLEX® patterns of Examples 1 and 2, respectively;

FIGS. 5A and 5B are cross-sectional scanning electron microscopic (SEM) images of the ECOFLEX® patterns of Examples 1 and 2, respectively;

FIGS. 6A and 6B are optical microscopic images at different magnifications of an ECOFLEX® pattern of Example 3 formed on a silicon substrate, in which the magnification of FIG. 6B is higher than that of FIG. 6A;

FIG. 6C is a graph of height versus width of the ECOFLEX® pattern of Example 3, obtained using a surface profiler;

FIGS. 7A and 7B are optical microscopic images showing results of an intensity test on the ECOFLEX® patterns of Comparative Example and Example 1, respectively;

FIG. 8 is an optical microscopic image of an ECOFLEX® pattern of Example 4;

FIG. 9 is an optical microscopic image of an ECOFLEX® pattern of Example 5;

FIG. 10 illustrates an optical microscopic image and a planar scanning electron microscopic (SEM) image of an ECOFLEX® pattern of Example 6;

FIG. 11 illustrates cross-sectional SEM images of the ECOFLEX® pattern of Example 6;

FIG. 12 illustrates optical microscopic images of an ECOFLEX® pattern of Example 7; and

FIG. 13 is a graph of electrostatic capacitance of a pressure sensor of Example 8 when a pressure was periodically applied thereto.

### DETAILED DESCRIPTION

Reference will now be made in detail to embodiments of a method of forming a pattern of an elastomeric polymer material, examples of which are illustrated in the accompanying drawings, wherein like reference numerals refer to the like elements throughout. In this regard, the present embodiments may have different forms and should not be construed as being limited to the descriptions set forth herein; rather, these embodiments are provided so that this disclosure will be thorough and complete, and will fully convey the concept of the invention to those skilled in the art. As used herein, the term “and/or” includes any and all combinations of one or more of the associated listed items. Expressions such as “at least one of,” when preceding a list of elements, modify the entire list of elements and do not modify the individual elements of the list.

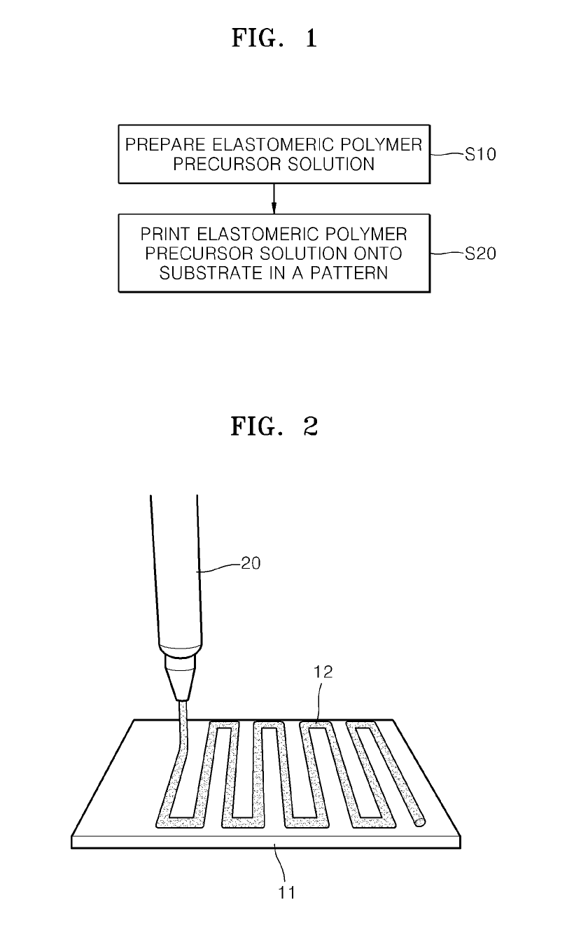

FIG. 1 is a flowchart illustrating a method of forming a pattern of an elastomeric polymer material, according to an embodiment of the present disclosure. Referring to FIG. 1, according to an embodiment of the present disclosure, firstly, an elastomeric polymer precursor solution or dispersion may be prepared (S10). For forming an elastomeric polymer, monomers of an elastomeric polymer material may need to be mixed with a curing agent to form a polymer. As used herein, a mixture of the monomer of the elastomeric polymer material with the curing agent is referred to as an elastomeric polymer precursor. In order for the elastomeric polymer precursor to have an appropriate viscosity to be dispensed from a printer, the elastomeric polymer precursor may be dissolved or dispersed in an appropriate solvent to give an elastomeric polymer precursor solution or dispersion having a relatively low viscosity appropriate for printing.

For example, the elastomeric polymer material may include polydimethlysiloxane, poly(styrene-b-butadiene-b-styrene) (SBS), poly(styrene-b-ethylenebutadiene-b-styrene) (SEBS), polychloroprene, butyl rubber, ethylenepropylene rubber, polyurethane, thiokol polysulfide, polyacrylate, acrylonitrile-butadiene rubber (NBR), isoprene rubber, or natural rubber. The elastomeric polymer precursor may include a monomer of the elastomeric polymer material. The elastomeric polymer material may also include a silicon-based polymer material. Non-limiting examples of commercially available silicon-based polymer materials are ECOFLEX® (Smooth on ltd.) and Dragon Skin® (Smooth on ltd.).

The curing agent may include, for example, a platinum catalyst.

Non-limiting examples of the solvent for dissolving the elastomeric polymer precursor are dichloromethane, chloroform, toluene, ethylacetate, tetrahydrofuran, dimethlysiloxane, dimethylformamide, and acetonitrile. An appropriate solvent may be selected from these solvents depending on the type of the elastomeric polymer material.

Next, the elastomeric polymer precursor solution may be printed onto an base in a desired pattern (S20). The printing of the pattern may be performed using, for example, nozzle printing, roll printing, or inkjet printing pattern. For example, the elastomeric polymer precursor solution may be sprayed onto the base through a dispenser of a printer to form a pre-designed pattern. In this regard, the temperature of the base may be maintained higher than a boiling point of the solvent in the elastomeric polymer precursor solution.

FIG. 2 is a schematic view illustrating forming a pattern of an elastomeric polymer material by using a nozzle printer, according to an embodiment of the present disclosure. Referring to FIG. 2, an elastomeric polymer precursor solution may be sprayed onto a base 11 through a dispenser of the nozzle printer to form a pattern 12 of the elastomeric polymer material. While the elastomeric polymer precursor solution is sprayed onto the base 11, either the dispenser 20 or the base 11 may be moved with respect to the other to form the pattern 12 of the elastomeric polymer material.

A temperature of the base 11 may be maintained to be higher than a boiling point of a solvent in the elastomeric polymer precursor solution to evaporate the solvent of the elastomeric polymer precursor solution from the base 11. For example, the temperature of the base 11 may be maintained about 10-50° C., 10-30° C., or 10-20° C. higher than the boiling point of the solvent. Once the solvent has been removed from the elastomeric polymer precursor solution, the remaining elastomeric polymer material precursor may be cured in a predetermined time so that the pattern 12 of the elastomeric polymer material may be formed. The temperature of the base 11 may promote the curing of the elastomeric polymer precursor.

Because printing method is used, the base 11 on which the pattern 12 of the elastomeric polymer material is formed may include a variety of materials without limitation. For example, the base 11 may be formed of various materials, which include, for example, a polymer, glass, silicon, or a metallic material, which may be in the form of a plate, film, fiber, or textile. For example, the base may be a polymer film, a polymer in fibrous form, glass, silicon wafers, metallic foils, fiberglass, ceramics, metal or polymer textile, or conductive layers.

The forming of the pattern 12 of the elastomeric polymer material (S20) may be repeated to control the thickness of the pattern 12 of the elastomeric polymer material. In particular, after the forming of the pattern 12 of the elastomeric polymer material is performed once while the dispenser 20 or the base 11 is moved, the same process may be performed while moving the dispenser 20 or the base 11 in the same manner to form another layer of the same pattern on the previous pattern 12 of the elastomeric polymer material, thereby thickening the pattern 12 of the elastomeric polymer material. Because the elastomeric polymer precursor solution sprayed through the dispenser 20 has a viscosity, the repeated process may lead to an increase of only a height of the pattern 12, without affecting a width of the pattern. The forming of the pattern 12 of the elastomeric polymer material (S20) may be performed one to tens of times. For example, the forming of the pattern 12 of the elastomeric polymer material (S20) may be performed 2 to 30 times, and in some embodiments, 2 to 20 times, and in some other embodiments, 2 to 10 times.

The pattern 12 of the elastomeric polymer material resulting from the above process may have a width of about 1-500 μm, and in some embodiments, a width of about 10-400 μm, and in some other embodiments, a width of about 50-300 μm. The printing (S20) may be repeated to form the pattern 12 of the elastomeric polymer material having a height of about 0.1-250 μm, and in some embodiments, a height of about 0.2-100 μm, and in some other embodiments, a height of about 0.5-10 μm. The pattern 12 of the elastomeric polymer material may have a linear form, a grid form, a circular firm, or a honeycomb form, but is not limited thereto.

When the dispenser 20 is moved over the fixed base 11 while the elastomeric polymer precursor solution is sprayed, the dispenser 20 may be moved in a first direction, a second direction, and a third direction perpendicular to the first direction and the second direction. For example, the first direction may be an x-axis direction, the second direction may be a y-axis direction, and the third direction may be a z-axis direction. For example, the z-axis direction may be perpendicular to the base 11, and the base 11 may be located on an x-y plane. When repeating the printing (S20), the method may further include moving the dispenser 20 in the z-axis direction to be at a constant distance from the previous pattern. For example, whenever the printing (S20) is further performed one more time, the dispenser 20 may be moved in the z-axis direction by about 0.01 mm away from the base 11.

On the other hand, when the base 11 is moved with respect to the fixed dispenser 20 while the elastomeric polymer precursor solution is sprayed, a stage (not shown) on which the base 11 is loaded may be moved in a first direction, a second direction, and a third direction perpendicular to the first direction and the second direction. For example, the first direction may be an x-axis direction, the second direction may be a y-axis direction, and the third direction may be a z-axis direction. For example, the z-axis direction may be perpendicular to the base 11, and the base 11 may be located on an x-y plane. When repeating the printing (S20), the method may further include moving the stage on which the base 11 is located in the z-axis direction to maintain a constant distance between the previous pattern on the base 11 and the dispenser 20. For example, whenever the printing (S20) is further performed one more time, the stage may be moved in the z-axis direction such that the base 11 loaded thereon is moved by about 0.01 mm away from the dispenser 20.

In some embodiments, when repeating the printing (S20), a new pattern may be formed not to overlap the previous pattern.

According to another embodiment, there is provided a method of manufacturing a pressure sensor by using a pattern of an elastomeric polymer material.

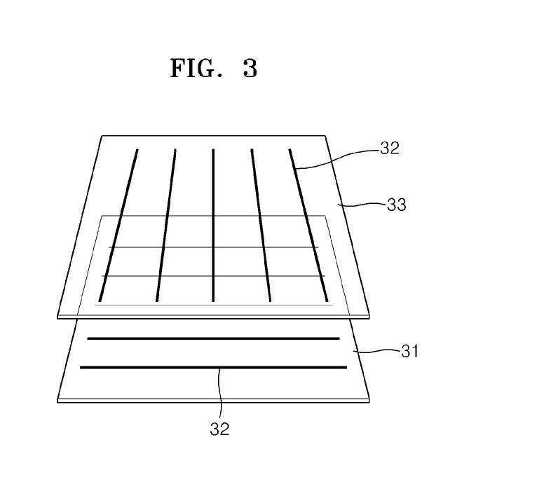

FIG. 3 is an exploded perspective view of a pressure sensor having a pattern of an elastomeric polymer material, according to an embodiment of the present disclosure. Referring to FIG. 3, first, a first electrode 31 of the pressure sensor may be formed. For example, the first electrode 31 may include a metal such as gold, silver, copper, iron, or indium, a conductive metal oxide such as an indium tin oxide (ITO), or a carbon nanotube, but is not limited thereto. Next, a pattern 32 of an elastomeric polymer material may be formed on the first electrode 31 by the method as described above with reference to FIGS. 1 and 2. The pattern 32 of the elastomeric polymer material may be, for example, in a linear form, a grid form, a circular form, or a honeycomb form, but is not limited thereto. The pattern 32 of the elastomeric polymer material may be formed in any of a variety of forms depending on requirements. Next, a second electrode 33 is formed on the pattern 32 of the elastomeric polymer material. Similar to the first electrode 31, the second electrode 33 may include a metal such as gold, silver, copper, iron, or indium, a conductive metal oxide such as an indium tin oxide (ITO), or a carbon nanotube, but is not limited thereto.

When a pressure or force is applied to the pressure sensor manufactured as described above, the pattern 32 of the elastomeric polymer material may be shrunk to narrow a distance between the first electrode 31 and the second electrode 33, which results in a change in capacitance. Accordingly, a level of the pressure or force applied to the pressure sensor may be detected from the change in the electrostatic capacitance. When the pressure is removed, the pattern 32 of the elastomeric polymer material may be restored due to its elasticity. Consequently, the initial distance between the first electrode 31 and the second electrode 33 and an initial capacitance at the initial distance between the first electrode 31 and the second electrode 33 may also be restored, and thus, the removal of the pressure may be detected.

Any of the methods of forming a pattern of an elastomeric polymer material, according to the above-described embodiments, may be used in a touch screen, a tactile sensor, a surgical robot, a medical device, a wearable device, or the like, in addition to a pressure sensor as described above.

### Example 1

5 g of a silicon-based elastomeric polymer material ECOFLEX® Supersoft 0010 (also referred to as “ECOFLEX® 0010,” available from Smooth-On, Inc.) were dissolved in 15 mL of dichloromethane (DCM) and then stirred for about 10 minutes to prepare an elastomeric polymer precursor solution.

The elastomeric polymer precursor solution was sprayed onto an ITO-coated polyethylene naphthalate (PEN) film of a size of 1.5×1.5 cm, through a dispenser (SUPER Σx and SHOTMASTER 300, available from Musashi Engineering, Inc.) to form a linear pattern made of ECOFLEX® Supersoft 0010 (also referred to as “Ecoflex pattern”). The operating conditions of the dispenser were as follows.

Dispenser speed: 50 m/s

Dispensing time: 330 ms

Pattern length: 1.41 cm

Injector pressure: 9.8 kPa,

Vacuum degree: 0.4 kPa

Stage temperature: 55° C.

### Example 2

An Ecoflex pattern was formed in substantially the same manner as in Example 1 by repeating the patterning in Example 1 ten times to increase the height of the Ecoflex pattern.

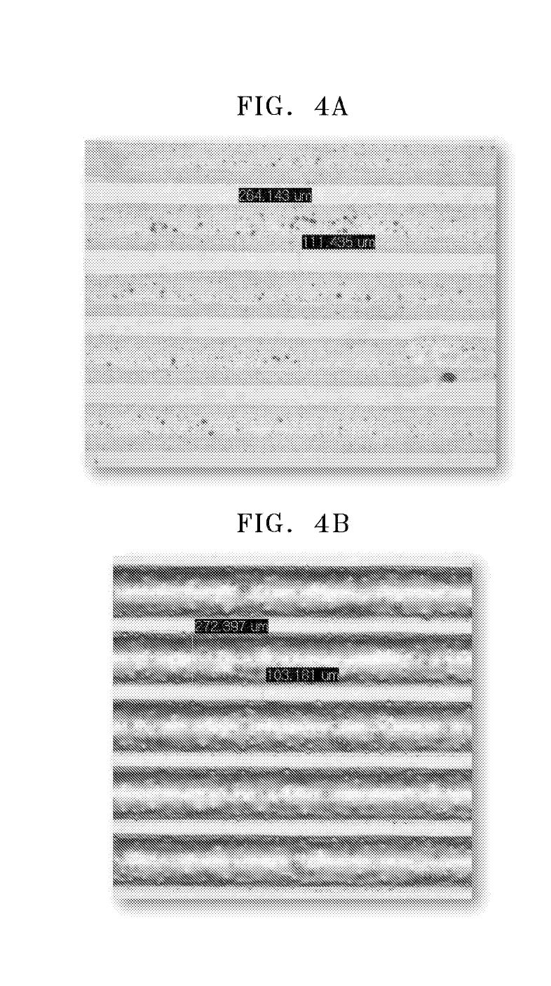

FIGS. 4A and 4B are optical microscopic images of the Ecoflex pattern of Example 1, and the Ecoflex pattern of Example 2, respectively. In the optical microscopic images of FIGS. 4A and 4B, the Ecoflex patterns of Examples 1 and 2 had a width of about 264 μm and a width of about 272 μm, respectively, which are very similar from each other.

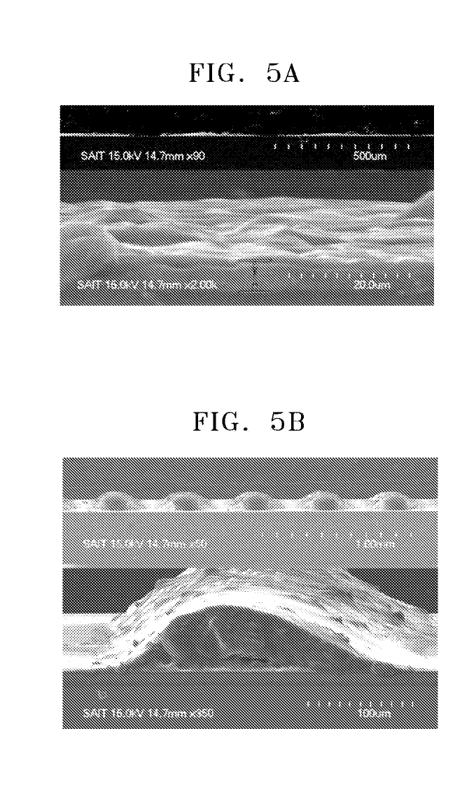

FIGS. 5A and 5B are cross-sectional scanning electron microscopic (SEM) images of the Ecoflex patterns of Examples 1 and 2, respectively. In FIGS. 5A and 5B, the lower images were at higher magnifications than the upper images. Referring to FIGS. 4A, 4B, 5A, and 5B, it was found that a height of the Ecoflex pattern could be increased, without changing the width of the pattern, through repeated nozzle-printing of the same pattern onto the previously formed Ecoflex pattern.

### Example 3

An Ecoflex pattern was formed in substantially the same manner as in Example 1, except that a silicon base of a size of about 1.5×1.5 cm was used instead of the PEN film, and a grid type Ecoflex pattern was formed through a single nozzle printing.

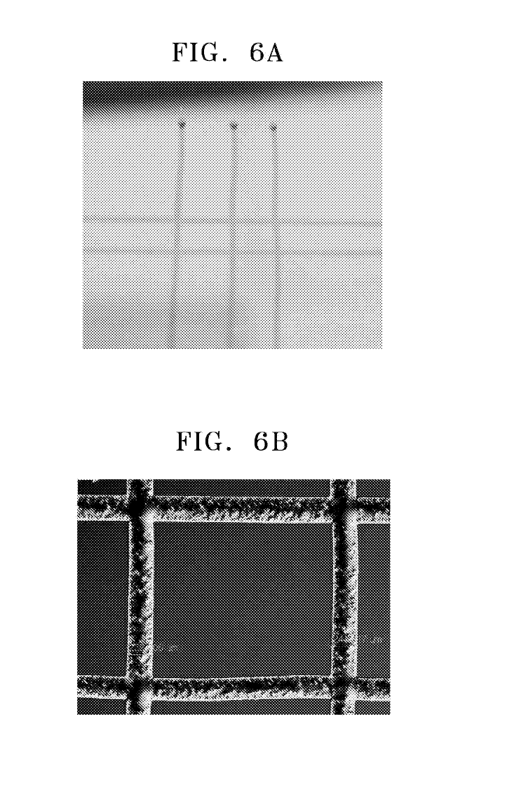

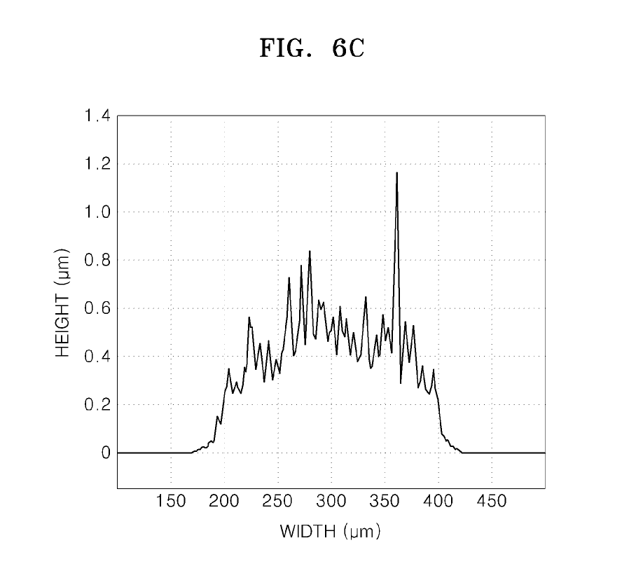

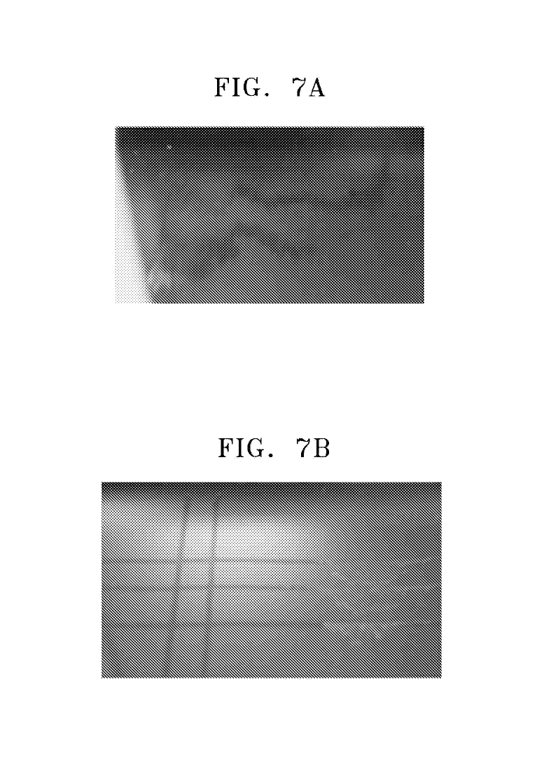

FIGS. 6A and 6B are optical microscopic images at different magnifications of the Ecoflex pattern of Example 3 formed on the silicon base, in which the magnification of FIG. 6B is higher than that of FIG. 6A. Referring to FIGS. 6A and 6B, it was found that a uniform grid type Ecoflex pattern having a width of about 230-240 μm uniform was formed on the silicon base. FIG. 6C is a graph of height versus width of the Ecoflex pattern of Example 3, obtained using a surface profiler. A width of the Ecoflex pattern of Example 3 in FIG. 6C was about 240 μm, which matches the width of Ecoflex pattern obtained from the optical microscopic image of FIG. 6B. A height of the Ecoflex pattern of Example 3 in FIG. 6C was about 600 nm.

### Comparative Example 1

An Ecoflex pattern was formed under substantially the same conditions as in Example 1, except that the stage on which the silicon base was loaded was not heated.

Pattern Intensity Test

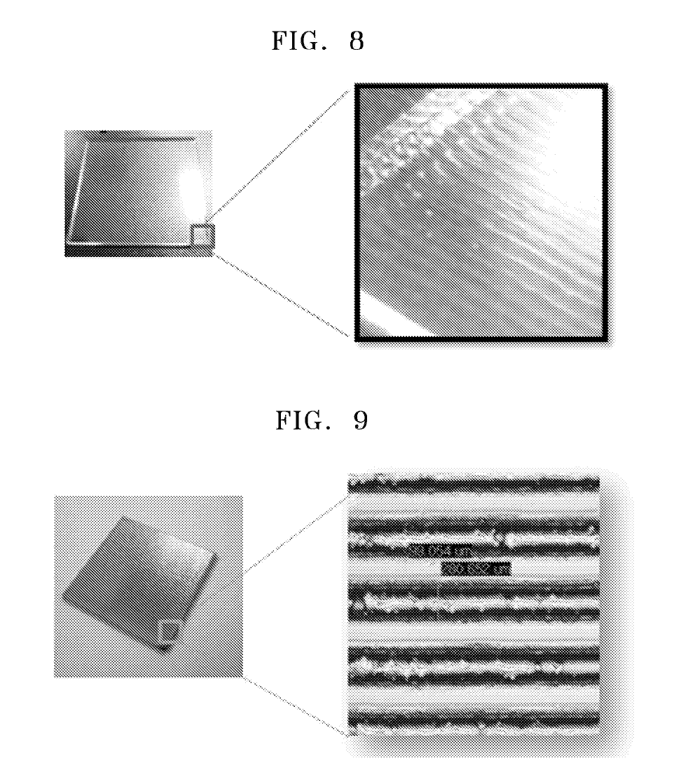

FIGS. 7A and 7B are optical microscopic images showing results of an intensity test on the Ecoflex patterns of Comparative Example 1 and Example 1, respectively. As shown in FIG. 7A, the Ecoflex pattern of Comparative Example 1, which was formed without heating the silicon base, was disintegrated by a soft touch. On the other hand, as shown in FIG. 7B, the Ecoflex pattern of Example 1, which was formed while heating the silicon base, was disintegrated only when a strong force was applied to rub, which indicates that the Ecoflex pattern of Example 1 formed while heating the silicon base has a strength as high as the starting material (Ecoflex® 0010) used to form the Ecoflex pattern.

### Example 4

An Ecoflex pattern was formed in substantially the same manner as in Example 2, except that a glass base of a size of about 3×3 cm coated with ITO was used instead of the PEN film. FIG. 8 is an optical microscopic image of the Ecoflex pattern of Example 4. It was found from FIG. 8 that a uniform Ecoflex pattern was formed on the glass base coated with ITO.

### Example 5

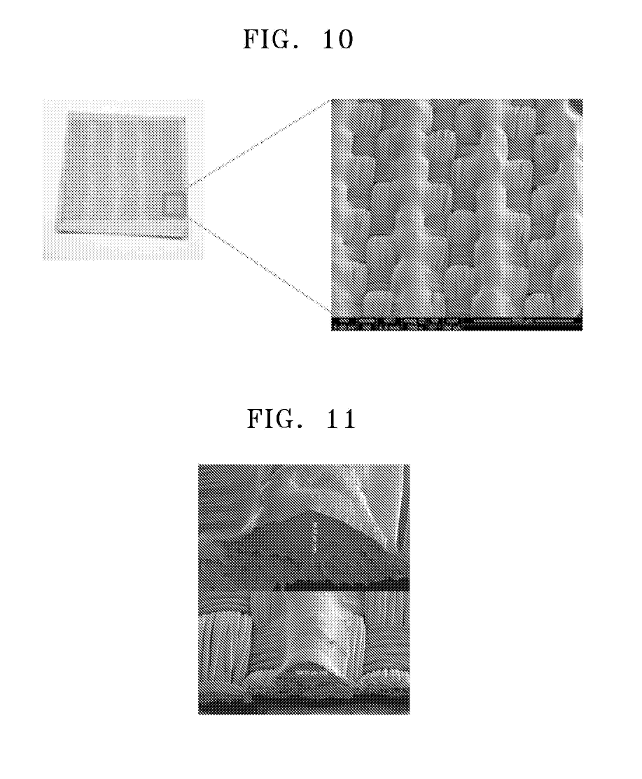

An Ecoflex pattern was formed in substantially the same manner as in Example 2, except that a gold (Au) plate base of a size of about 1.5×1.5 cm was used instead of the PEN film. FIG. 9 is an optical microscopic image of the Ecoflex pattern of Example 5. It was found from the image of FIG. 9 that a uniform Ecoflex pattern was formed on the Au base.

### Example 6

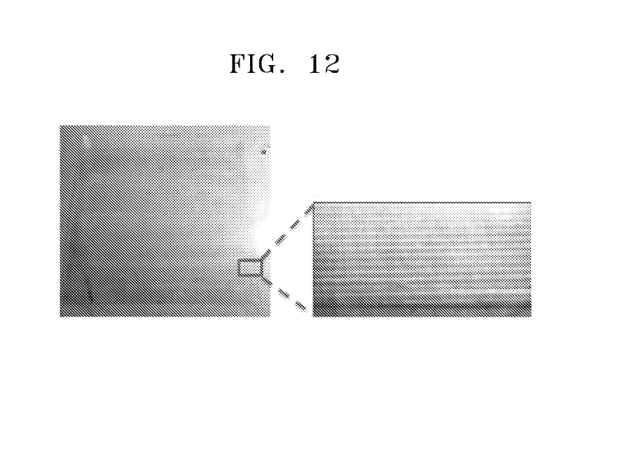

An Ecoflex pattern was formed in substantially the same manner as in Example 2, except that an Au textile of a size of about 1.5×1.5 cm was used instead of the PEN film. FIG. 10 illustrates an optical microscopic image and a planar scanning electron microscopic (SEM) image of the Ecoflex pattern of Example 6. The SEM image of FIG. 10 shows that a uniform Ecoflex pattern was formed on the Au textile. FIG. 11 illustrates cross-sectional SEM images of the Ecoflex pattern of Example 6. A height and width of the Ecoflex pattern of Example 6 were measured from upper and lower SEM images in FIG. 11, respectively. It was found from the SEM images of FIG. 11 that an Ecoflex pattern having a height of about 66 μm and a width of about 158 nm was uniformly formed on the Au textile.

### Example 7

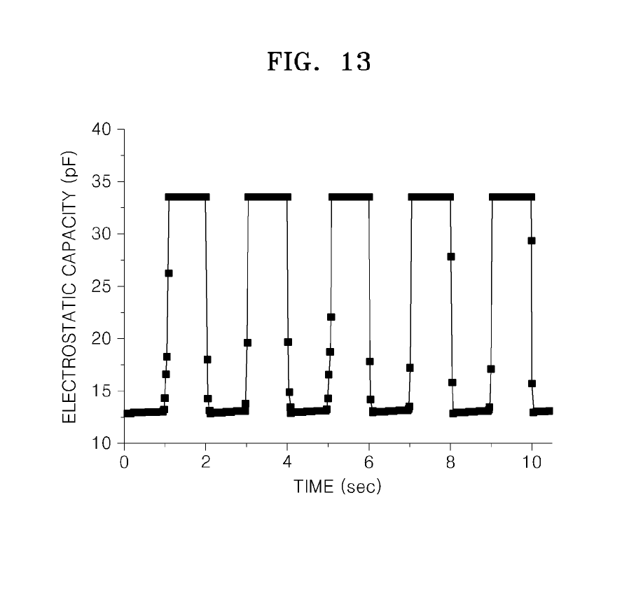

An Ecoflex pattern was formed in substantially the same manner as in Example 2, except that a PEN film of a size of about 8×8 cm was used instead of the PEN film of a size of about 1.5×1.5 cm. FIG. 12 illustrates optical microscopic images of an Ecoflex pattern of Example 7. It was found from the images of FIG. 12 that a uniform Ecoflex pattern was formed even on a large PEN film of a size of about 8×8 cm.

### Example 8

### Manufacture of capacitive pressure sensor

Two Ecoflex patterns were formed respectively on two separate ITO-coated PEN films of a size of about 1.5×1.5 cm, respectively, in substantially the same manner as in Example 2. The two ITO-coated PEN films with the Ecoflex patterns were overlapped to each other such that the two Ecoflex patterns thereon were contacted and form a grid pattern, and then copper wires were connected to the two ITO-coated PEN films, respectively, to manufacture a capacitive pressure sensor. A pressure was periodically applied to the capacitive pressure sensor by using a manual pressure gauge. A force of 1 N was applied perpendicularly to the PEN films of the capacitive pressure sensor for about 1 second and then the force was released for about 1 second. This was repeated five times.

FIG. 13 is a graph of capacitance of the capacitive pressure sensor of Example 8 when a pressure was periodically applied thereto. Referring to FIG. 13, it was found that the periodic pressure difference leads to the periodic electrostatic capacitance. This result indicates that an elastomeric polymer material pattern formed on a base by nozzle-printing while heating the base may be used to manufacture a pressure sensor.

As described above, according to the one or more of the above embodiments of the present disclosure, an elastomeric polymer material pattern may be easily formed by spraying a solution of an elastomeric polymer material dissolved in a solvent onto a base in a pattern while heating the base above a boiling point of the solvent to evaporate the solvent.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A method of forming a pattern of an elastomeric polymer material, the method comprising:
(a) dissolving or dispersing a precursor of the elastomeric polymer material in a solvent to give an elastomeric polymer precursor solution; and
(b) printing the elastomeric polymer precursor solution onto a base to form a pattern of the elastomeric polymer, wherein a temperature of the base is maintained to be about 10° C.-30° C. higher than a boiling point of the solvent.

2. The method of claim 1, wherein the precursor of the elastomeric polymer material comprises a monomer of the elastomeric polymer material and a curing agent.

3. The method of claim 1, wherein the elastomeric polymer material comprises a silicon-based polymer material.

4. The method of claim 1, wherein the elastomeric polymer material comprises polydimethlysiloxane, poly(styrene-b-butadiene-b-styrene), poly(styrene-b-ethylenebutadiene-b-styrene), polychloroprene, butyl rubber, ethylenepropylene rubber, polyurethane, thiokol polysulfide, polyacrylate, acrylonitrile-butadiene rubber, isoprene rubber, or natural rubber.

5. The method of claim 1, wherein the curing agent comprises a platinum catalyst.

6. The method of claim 1, wherein the solvent comprises dichloromethane, chloroform, toluene, ethylacetate, tetrahydrofuran, dimethlysiloxane, dimethylformamide, or acetonitrile.

7. The method of claim 1, wherein the elastomeric polymer precursor solution has a viscosity that allows forming the pattern by printing.

8. The method of claim 1, wherein the printing is performed by nozzle printing, roll printing, or inkjet printing.

9. The method of claim 1, wherein the base comprises a polymer film, a polymer in fibrous form, glass, silicon wafers, metallic foils, fiberglass, ceramics, or conductive layers.

10. The method of claim 1, wherein the temperature of the base is maintained to be about 10° C.-20° C. higher than the boiling point of the solvent.

11. The method of claim 1, wherein the pattern has a width of about 1-500 μm.

12. The method of claim 1, wherein the step (b) is repeated to increase a height of the pattern of the elastomeric polymer material.

13. The method of claim 12, wherein the pattern of the elastomeric polymer material has a height of about 0.1-250 μm.

14. The method of claim 12, wherein the printing is performed by a printer which comprises a dispenser for dispensing the elastomeric polymer precursor solution, wherein the dispenser is movable in a first direction and a second direction that are parallel to a surface of the base and in a third direction perpendicular to the surface of the base.

15. The method of claim 14, further comprising moving the dispenser in the third direction to maintain a constant distance from the previously formed pattern when the step (b) of the forming of the pattern is repeated.

16. The method of claim 12, wherein the printing is performed by a printer, said printer comprising a dispenser for dispensing the elastomeric polymer precursor solution and a stage on which the base is to be loaded, and the stage is movable in a first direction and a second direction that are parallel to a surface of the base and in a third direction perpendicular to the surface of the base.

17. The method of claim 16, further comprising moving the stage in the third direction so that the dispenser maintains a constant distance from the previously formed pattern when the step (b) of the forming of the pattern is repeated.

18. A method of manufacturing a pressure sensor, the method comprising:
forming a first electrode;
forming a pattern of an elastomeric polymer material by the method of claim 1; and
forming a second electrode on the pattern of the elastomeric polymer material.

19. The method of claim 18, wherein the first electrode comprises indium tin oxide, gold, silver, copper, iron, indium, or carbon nanotube.

20. The method of claim 18, wherein the second electrode comprises indium tin oxide, gold, silver, copper, iron, indium, or carbon nanotube.
